(19) United States
(12) Patent Application Publication
(10) Pub. No.: US 2024/0339094 A1
(43) Pub. Date: Oct. 10, 2024

(54) AUDIO SYNTHESIS METHOD, AND COMPUTER DEVICE AND COMPUTER-READABLE STORAGE MEDIUM

(71) Applicant: TENCENT MUSIC ENTERTAINMENT TECHNOLOGY (SHENZHEN) CO., LTD., Shenzhen (CN)

(72) Inventors: Kesong LU, Shenzhen (CN); Weifeng ZHAO, Shenzhen (CN); Wenjiang ZHOU, Shenzhen (CN); Zhenqing LIU, Shenzhen (CN); Zhiqiang WENG, Shenzhen (CN); Xu LI, Shenzhen (CN); Feifei CHEN, Shenzhen (CN)

(21) Appl. No.: 18/291,538

(22) PCT Filed: Oct. 10, 2022
(86) PCT No.: PCT/CN2022/124379

§ 371 Date: Jan. 23, 2024

(30) Foreign Application Priority Data
Oct. 12, 2021 (CN) 202111189249.8

(51) Int. Cl. G10H 1/00

(52) U.S. Cl. CPC G10H 1/0008; G10H 2210/105; G10H 2210/571; G10H 2250/471

(57) ABSTRACT

Provided is an audio synthesis method. Music score data of target music is acquired, wherein the music score data includes audio data identifiers and performance time information corresponding to a plurality of sub-audios, an instrumental timbre corresponding to each of the sub-audios being matched with a hearing-impaired hearing timbre; the sub-audios based on the audio data identifiers corresponding to each of the sub-audios is acquired; and a synthetic audio of the target music is generated by performing a fusion process on the sub-audios based on the performance time information corresponding to each of the sub-audios.

This application is a U.S. national stage of international application No. PCT/CN2022/124379, filed on Oct. 10, 2022, which claims priority to Chinese Patent Application No. 202111189249.8, filed on Oct. 12, 2021, and entitled “AUDIO SYNTHESIS METHOD AND APPARATUS, AND DEVICE AND COMPUTER-READABLE STORAGE MEDIUM,” the contents of which are herein incorporated by reference in their entireties.

### TECHNICAL FIELD

The present disclosure relates to the field of computer technologies, and in particular, relates to an audio synthesis method, a computer device, and a computer-readable storage medium.

### BACKGROUND

With the continuous abundance of audio resources (such as music), people can listen to the music at any time and any place. However, hearing-impaired people are prone to inaudible problems when listening to audio due to insufficient sensitivity to the high-frequency components of sound. Therefore, there is a need for an audio synthesis method to synthesize audios that can be heard by hearing-impaired people.

### SUMMARY

Embodiments of the present disclosure provide an audio synthesis method, a computer device, and a computer-readable storage medium. The technical solutions are as follows.

Some embodiments of the present disclosure provide an audio synthesis method. The method includes:
acquiring music score data of target music, wherein the music score data includes audio data identifiers and performance time information corresponding to a plurality of sub-audios, an instrumental timbre corresponding to each of the sub-audios being matched with a hearing-impaired hearing timbre;
acquiring the sub-audios based on the audio data identifiers corresponding to each of the sub-audios; and
generating a synthetic audio of the target music by performing a fusion process on the sub-audios based on the performance time information corresponding to each of the sub-audios.

In some embodiments, in a frequency spectrum of an instrument corresponding to each of the sub-audios, a ratio of energy of a low-frequency band to energy of a high-frequency band is greater than a ratio threshold, wherein the low-frequency band is a band lower than a frequency threshold, the high-frequency band is a band higher than the frequency threshold, and the ratio threshold indicates a condition that the ratio of the energy of the low-frequency band to the energy of the high-frequency band in a frequency spectrum of audio which is capable of being heard by hearing-impaired people needs to be satisfied.

In some embodiments, acquiring the music score data of the target music includes:
determining the audio data identifiers and the performance time information corresponding to the plurality of sub-audios based on a tempo, a time signature, and a chord list of the target music.

In some embodiments, the plurality of sub-audios include a drumbeat sub-audio and a chord sub-audio; and determining the audio data identifiers and the performance time information corresponding to the plurality of sub-audios based on the tempo, the time signature, and the chord list of the target music includes:
determining an audio data identifier and performance time information corresponding to the drumbeat sub-audio based on the tempo and the time signature of the target music;
determining an audio data identifier and performance time information corresponding to the chord sub-audio based on the tempo, the time signature, and the chord list of the target music; and
acquiring the audio data identifiers and the performance time information corresponding to the plurality of sub-audios by composing the audio data identifier and the performance time information corresponding to the drumbeat sub-audio and the audio data identifier and the performance time information corresponding to the chord sub-audio.

In some embodiments, determining the audio data identifier and the performance time information corresponding to the drumbeat sub-audio based on the tempo and the time signature of the target music includes:
determining an audio data identifier corresponding to the time signature and the tempo of the target music, and determining the audio data identifier corresponding to the time signature and the tempo of the target music as the audio data identifier corresponding to the drumbeat sub-audio; and
determining the performance time information corresponding to the drumbeat sub-audio based on the time signature and the tempo of the target music.

In some embodiments, the chord list includes a chord identifier and performance time information corresponding to the chord identifier; and
determining the audio data identifier and the performance time information corresponding to the chord sub-audio based on the tempo, the time signature, and the chord list of the target music includes:
determining an audio data identifier corresponding to the chord identifier based on the tempo and the time signature of the target music; and
determining the performance time information and the audio data identifier corresponding to the chord identifier as the performance time information and the audio data identifier corresponding to the chord sub-audio.

In some embodiments, generating the synthetic audio of the target music by performing the fusion process on the sub-audios based on the performance time information corresponding to each of the sub-audios includes:
acquiring an intermediate audio of the target music by performing the fusion process on the sub-audios based on the performance time information corresponding to each of the sub-audios; and
acquiring the synthetic audio of the target music by performing a frequency domain compression process on the intermediate audio of the target music.

In some embodiments, acquiring the synthetic audio of the target music by performing the frequency domain compression process on the intermediate audio of the target music includes:
acquiring a first sub-audio of a first frequency interval corresponding to the intermediate audio and a second sub-audio of a second frequency interval corresponding to the intermediate audio, wherein a frequency of the first frequency interval is less than a frequency of the second frequency interval;
acquiring a third sub-audio by performing a gain compensation on the first sub-audio based on a first gain coefficient, and acquiring a fourth sub-audio by performing a gain compensation on the second sub-audio based on a second gain coefficient;
acquiring a fifth sub-audio by performing a compression frequency shift process on the fourth sub-audio, wherein a lower limit of a third frequency interval corresponding to the fifth sub-audio is equal to a lower limit of the second frequency interval; and
acquiring the synthetic audio of the target music by performing the fusion process on the third sub-audio and the fifth sub-audio.

In some embodiments, acquiring the fifth sub-audio by performing the compression frequency shift process on the fourth sub-audio includes:
acquiring a sixth sub-audio by performing a frequency compression of a target ratio on the fourth sub-audio; and
acquiring the fifth sub-audio by performing a frequency upshift of a target value on the sixth sub-audio, wherein the target value is equal to a difference between the lower limit of the second frequency interval and a lower limit of a fourth frequency interval corresponding to the sixth sub-audio.

Some embodiments of the present disclosure provide a computer device, including a processor and a memory. The memory stores at least one program code. The processor, when loading and executing the at least one program code, is caused to perform the audio synthesis method as described above.

Some embodiments of the present disclosure provide a non-transitory computer-readable storage medium, including at least one program code. The at least one program code, when loaded and executed by a processer of a computer, causes the computer to perform the audio synthesis method as described above.

Some embodiments of the present disclosure provide a computer program or a computer program product, including a processor and a memory. The at least one program code, when loaded and executed by a processer of a computer, causes the computer to perform the audio synthesis method as described above.

### BRIEF DESCRIPTION OF DRAWINGS

For clearer descriptions of the technical solutions in the embodiments of the present disclosure, the following briefly introduces the accompanying drawings to be required in the descriptions of the embodiments. Apparently, the accompanying drawings in the following description show merely some embodiments of the present disclosure, and persons of ordinary skills in the art may still derive other drawings from these accompanying drawings without creative efforts.

FIG. 1 is a schematic diagram of an implementation environment of an audio synthesis method according to some embodiments of the present disclosure;

FIG. 2 is a flowchart of an audio synthesis method according to some embodiments of the present disclosure;

FIG. 3 is a numbered musical notation of the fourth, fifth, and sixth music measures of the song “Heaven” according to some embodiments of the present disclosure;

FIG. 4 is a numbered musical notation corresponding to a synthetic audio of a fourth, a fifth, and a sixth music measures of the song “Heaven” according to some embodiments of the present disclosure;

FIG. 5 is a flowchart of an audio synthesis method according to some embodiments of the present disclosure;

FIG. 6 is a schematic structural diagram of an audio synthesis apparatus according to some embodiments of the present disclosure;

FIG. 7 is a schematic structural diagram of a terminal device according to some embodiments of the present disclosure; and

FIG. 8 is a schematic structural diagram of a server according to some embodiments of the present disclosure.

### DETAILED DESCRIPTION

The present disclosure is described in further detail with reference to the accompanying drawings, to clearly present the objects, technical solutions, and advantages of the present disclosure.

The terms involved in the embodiments of the present disclosure are described in detail hereinafter.
Wide Dynamic Range Compressor (WDRC): a dynamic range control algorithm, characterized by a low compression ratio/low compressing threshold and supporting to adjust a compression metric dynamically.
Cross-Fade: an overlapped part of the first and last parts of two audio clips are spliced together into a complete audio clip by interweaving fade-in and fade-out.
Non-Linear Compression Frequency Shift: a method for hearing-impaired people, in which high-frequency components are compressed and then shifted to a low-frequency region where hearing-impaired people have residual hearing.

In some practices, taking a scenario in which the audio resource is music as an example, when listening to music, if a hearing-impaired person does not wear a hearing aid, he or she can only hear low-frequency components of the sound in the music, and cannot hear high-frequency components of the sound in the music, so that the music heard by the hearing-impaired person is intermittent and not smooth enough. Consequently, the music heard by the hearing-impaired person is distorted and has poor sound quality, which leads to a worse music-listening effect for the hearing-impaired person.

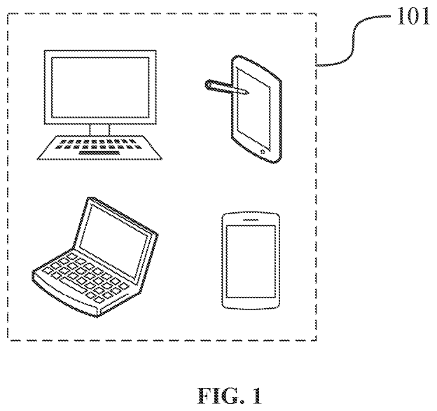

FIG. 1 is a schematic diagram of an implementation environment of an audio synthesis method according to some embodiments of the present disclosure. As illustrated in FIG. 1, the embodiment environment includes a computer device 101. The audio synthesis method according to the embodiments of the present disclosure is performed by the computer device 101. For example, the computer device 101 is a terminal device or a server, which is not limited herein.

The terminal device is at least one of a smartphone, a game console, a desktop computer, a tablet computer, an e-book reader, a moving picture experts group audio layer III (MP3) player, a moving picture experts group audio layer IV (MP4) player, or a laptop computer.

The server is a single server, a cluster of servers consisting of a plurality of servers, or any one of a cloud computing platform and a virtualization center, which is not limited herein. The server communicates with the terminal device over a wired network or a wireless network. The server has functions of data sending and receiving, data processing, data storage, and the like, which are not limited herein.

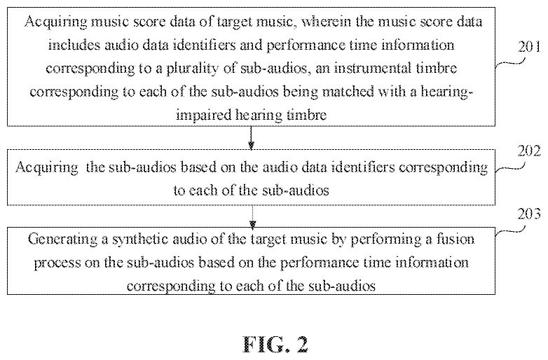

Based on the above embodiment environment, some embodiments of the present disclosure provide an audio synthesis method. Taking the flowchart of an audio synthesis method according to some embodiments of the present disclosure illustrated in FIG. 2 as an example, the method is performed by the computer device 101 of FIG. 1. As illustrated in FIG. 2, the method includes the following steps.

In step 201, music score data of target music is acquired, wherein the music score data includes audio data identifiers and performance time information of a plurality of sub-audios, and an instrumental timbre corresponding to each of the sub-audios is matched with a hearing-impaired hearing timbre.

In some embodiments of the present disclosure, the target music includes sounds played by an instrument. The target music is pure music, light music, or a song, which is not limited herein.

In some embodiments, in a frequency spectrum of an instrument corresponding to each of the sub-audios, a ratio of the energy of a low-frequency band to the energy of a high-frequency band is greater than a ratio threshold, wherein the low-frequency band is a band lower than a frequency threshold, the high-frequency band is a band higher than the frequency threshold, and the ratio threshold indicates a condition that the ratio of the energy of the low-frequency band to the energy of the high-frequency band in a frequency spectrum of an audio that is capable of being heard by hearing-impaired people needs to be satisfied.

The frequency threshold is acquired based on experiments, which is not limited herein. For example, the frequency threshold is 2000 Hz. The ratio threshold is a minimum value of the ratio of the energy of the low-frequency band to the energy of the high-frequency band in the frequency spectrum of the audio that is capable of being heard by hearing-impaired people.

For example, a plurality of audios are stored in the computer device. Each of the audios corresponds to a different ratio of the energy of the low-frequency band to the energy of the high-frequency band, and the ratios of the energy of the low-frequency bands to the energy of the high-frequency bands corresponding to different audios differ from each other by a value, such as 2%. The audios are played in an order of the ratios of the energy of the low-frequency bands to the energy of the high-frequency bands from high to low, and hearing-impaired people listen to the audios. In the case that hearing-impaired people hear the audio in which the ratio of the energy of the low-frequency band to the energy of the high-frequency band is 50%, but hearing-impaired people are not able to hear the audio in which the ratio of the energy of the low-frequency band to the energy of the high-frequency band is 48%, the ratio threshold is defined to be 50%.

Generally, the frequency range of the sound heard by normal people is roughly within 20,000 Hz, and the frequency range of the sound heard by hearing-impaired people is roughly within 8000 Hz. The instrument corresponding to the sub-audios in the embodiments of the present disclosure has a vocalization frequency mainly within 8000 Hz, which is designed for hearing-impaired people, such that hearing-impaired people hear more clearly. Therefore, the synthetic audio acquired by synthesizing these sub-audios is also better heard by hearing-impaired people.

In some embodiments, the process of determining which instrument timbres match the hearing-impaired hearing timbre includes: acquiring a sound corresponding to each instrument and playing the sound corresponding to the instrument for hearing-impaired people. Based on feedback information from the hearing-impaired people, it is determined which instrument timbres are matched with the hearing-impaired hearing timbre.

In the case that the feedback information indicates that hearing-impaired people are able to hear a sound, it is determined that an instrument timbre of an instrument corresponding to the sound that is heard by hearing-impaired people is matched with the hearing-impaired hearing timbre. In the case that the feedback information indicates that the hearing-impaired person people fails to hear the sound, it is determined that the instrumental timbre of an instrument corresponding to the sound that is not heard by hearing-impaired people is not matched with the hearing-impaired hearing timbre.

For example, a first sound, a second sound, and a third sound are acquired, wherein the first sound corresponds to a piano, the second sound corresponds to a bass, and the third sound corresponds to a snare drum. The three sounds are played separately so that hearing-impaired people listen to the three sounds separately. In the case that hearing-impaired people hear the second sound and the third sound but do not hear the first sound, it is determined that timbres of the bass and the snare drum are matched with the hearing-impaired hearing timbre, and the timbre of the piano is not matched with the hearing-impaired hearing timbre.

It should be noted that sounds respectively corresponding to all instruments are acquired and then heard by hearing-impaired people, such that the instrument timbres being matched with the hearing-impaired hearing timbre are determined. The embodiments of the present disclosure give the description only taking a scenario where the above two instrument timbres are matched with the hearing-impaired hearing timbre as an example, and there are more or less musical instrument timbres matching the hearing-impaired hearing timbre, which are not limited herein.

In some embodiments, the sub-audios corresponding to the audio data identifiers and the performance time information included in the music score data of the target music are drumbeat sub-audios, or chord sub-audios, or both the drumbeat sub-audios and the chord sub-audios, which are not limited herein. In the case that the sub-audios corresponding to the audio data identifiers and the performance time information included in the music score data include only the drumbeat sub-audios or only the chord sub-audios, the synthetic audio of the target music acquired based on the music score data, although is heard by hearing-impaired people, is boring and homogeneous. Therefore, the embodiments of the present disclosure take a scenario where the sub-audios corresponding to the audio data identifiers and the performance time information in the music score data include the drumbeat sub-audios and the chord sub-audios. The music score data includes the audio data identifier and the performance time information corresponding to the drumbeat sub-audio and the audio data identifier and the performance time information corresponding to the chord sub-audio.

It should be noted that in the case that the sub-audios corresponding to the audio data identifier and the performance time information in the music score data of the target music are the drumbeat sub-audios or the chord sub-audios, the process of acquiring the synthetic audio of the target music is similar to the process of acquiring the synthetic audio of the target music in the case that the sub-audios corresponding to the audio data identifier and the performance time information in the music score data of the target music include the drumbeat sub-audios and the chord sub-audios.

In some embodiments, the process of acquiring the music score data of the target music includes: based on a tempo, a time signature, and a chord list of the target music, determining the audio data identifiers and the performance time information corresponding to the plurality of sub-audios.

Prior to determining the audio data identifiers and the performance time information corresponding to the plurality of sub-audios based on the tempo, the time signature, and the chord list of the target music, the tempo, the time signature, and the chord list of the target music need to be determined. The methods for determining the tempo, the time signature, and the chord list of the target music include, but are not limited to, the following three methods. In the first method, an audio corresponding to the target music is acquired, and the tempo, the time signature, and the chord list of the target music are acquired by processing the audio corresponding to the target music with an audio analysis tool. In the second method, a music score corresponding to the target music is acquired, and the tempo, the time signature, and the chord list of the target music are determined based on the music score corresponding to the target music, wherein the music score is a staff or a numbered musical notation, which is not limited herein. In the third method, an electronic music score of the target music is acquired, and the tempo, the time signature, and the chord list of the target music are acquired by processing the electronic music score of the target music using a score analysis tool, wherein the electronic music score consists of notes corresponding to beats included in the target music, and the electronic music score also includes information such as the tempo and the time signature.

In some embodiments, the process of acquiring the tempo, the time signature, and the chord list of the target music by processing the audio corresponding to the target music using the audio analysis tool includes: inputting the audio corresponding to the target music into the audio analysis tool, and acquiring the tempo, the time signature, and the chord list of the target music based on an output result of the audio analysis tool. The audio analysis tool is configured to acquire the tempo, the time signature, and the chord list corresponding to the audio by analyzing the audio. Other information about the audio is acquired by analyzing the audio with the audio analysis tool, which is not limited herein. The audio analysis tool is a machine learning model, such as a neural network model.

In some embodiments, the process of determining the tempo, the time signature, and the chord list of the target music based on the music score corresponding to the target music includes: determining the tempo, the time signature, and the chord list of the target music by a user who has musicianship based on the music score corresponding to the target music.

In some embodiments, the process of acquiring the tempo, the time signature, and the chord list of the target music by processing the electronic music score of the target music with the score analysis tool includes: inputting the electronic music score corresponding to the target music into the score analysis tool for analyzing the electronic music score, and acquiring the tempo, the time signature, and the chord list of the target music. The specific process is as follows.

A chord library, which stores a correspondence between chord identifiers and chord electronic music scores, is stored in the computer device. The process of acquiring the chord list of the target music by analyzing the electronic music score of the target music with the score analysis tool is as follows. A fragment of the electronic music score corresponding to a music measure is acquired with the score analysis tool, a chord electronic music score that is matched with the fragment of the electronic music score in the above correspondence is searched, and a chord identifier corresponding to the resulting chord electronic music score is determined as a chord identifier of the music measure. In this way, performance time information of the music measure and the chord identifier corresponding to the music measure are further acquired. According to the method, the chord list of the target music is acquired by traversing all the measures of the target music. In addition, the tempo and the time signature are directly acquired by the score analysis tool in the electronic music score of the target music.

The chord list includes a chord identifier and performance time information corresponding to the chord identifier. The chord identifier is a chord name or a string of characters consisting of notes that compose the chord, which is not limited herein. For example, in the case that the chord name is a C chord and the notes composing the C chord are 123, the chord identifier is the C chord or 123.

In some embodiments, the performance time information includes any two of a start beat, an end beat, and a duration beat. For example, the performance time information includes the start beat and the end beat. For example, the performance time information is (1, 4). That is, the performance time information starts at the first beat and ends at the fourth beat. Another example is that the performance time information includes the start beat and the duration beat. For example, the performance time information is [1, 4]. That is, the performance time information starts at the first beat and lasts for four beats. Another example is that the performance time information includes the duration beat and the end beat. For example, the performance time information is [4, 4]. That is, the performance time information lasts for four beats and ends at the fourth beat.

For example, the target music has a time signature of 4/4 beat and a tempo of 60 beats/minute, and a chord list is listed in Table 1 below. The 4/4 beat means that a quarter note is a beat and a music measure has 4 beats, and the 60 beats/minute means that there are 60 beats in one minute, with a time interval of 1 second between each beat.

TABLE 1

| Performance time information | |
|---|---|
| corresponding to chord identifier | chord identifier |
| (1, 4) | N.C |
| (5, 8) | N.C |
| (9, 12) | Chord A |
| (13, 16) | Chord E |
| . . . | . . . |
| (45, 48) | Chord C |
| . . . | . . . |
| (57, 60) | Chord F#m |
| . . . | . . . |

As illustrated in Table 1, (1, 4) indicates that it starts on the first beat and ends on the fourth beat, N.C indicates that there is no chord. The chord identifiers as well as the performance time information corresponding to the chord identifiers are listed in Table 1, which are not repeated herein.

It should be noted that the above is only an example of the chord identifiers and the performance time information corresponding to the chord identifiers included in the target music provided by the embodiments of the present disclosure, which does not constitute any limitation to the chord identifiers and the performance time information corresponding to the chord identifiers included in the target music.

In some embodiments, the plurality of sub-audios include the drumbeat sub-audio and the chord sub-audio. The process of determining the audio data identifiers and the performance time information corresponding to the plurality of sub-audios based on the tempo, the time signature, and the chord list of the target music includes: determining an audio data identifier and performance time information corresponding to the drumbeat sub-audio based on the tempo and the time signature of the target music; and determining an audio data identifier and performance time information corresponding to the chord sub-audios based on the tempo, the time signature, and the chord list of the target music. The audio data identifier and the performance time information corresponding to the drumbeat sub-audio and the audio data identifier and the performance time information corresponding to the chord sub-audio compose the audio data identifiers and the performance time information corresponding to the plurality of sub-audios.

The process of determining the audio data identifier and the performance time information corresponding to the drumbeat sub-audio based on the tempo and the time signature of the target music includes: determining an audio data identifier corresponding to the time signature and the tempo of the target music, and determining the audio data identifier corresponding to the time signature and the tempo of the target music as the audio data identifier corresponding to the drumbeat sub-audio; and determining the performance time information corresponding to the drumbeat sub-audio based on the time signature and the tempo of the target music.

In some embodiments, before acquiring the audio data identifier and the performance time information corresponding to the drumbeat sub-audio, a drumbeat instrument needs to be determined. The drumbeat instrument is determined manually by designating a drumbeat instrument among a plurality of drumbeat instruments or is determined randomly by a computer device, which is not limited herein. It is noted that the timbre of the drumbeat instrument determined in the above ways needs to be matched with the hearing-impaired hearing timbre.

For example, the drumbeat instrument as determined is a snare drum.

In some embodiments, after the drumbeat instrument is determined, a plurality of drumbeat sub-audios corresponding to the determined drumbeat instrument are acquired from a first audio library, and then, based on the tempo and the time signature of the target music, a drumbeat sub-audio corresponding to the tempo and the time signature of the target music is determined among the plurality of drumbeat sub-audios, and an audio data identifier corresponding to the drumbeat sub-audio corresponding to the tempo and the time signature of the target music are determined as the audio data identifier corresponding to the drumbeat sub-audio included in the music score data.

In some embodiments, the first audio library is pre-stored in the computer device. A plurality of drumbeat sub-audios are stored in the first audio library, and instrumental timbres corresponding to the plurality of drumbeat sub-audios stored in the first audio library are matched with the hearing-impaired hearing timbre. Each drumbeat sub-audio in the first audio library corresponds to one audio data identifier.

The drumbeat sub-audio stored in the first audio library is an audio clip in a moving picture experts group audio layer III (MP3) format, or is an audio clip in another format, which is not limited herein.

Correspondences between audio data identifiers corresponding to drumbeat sub-audios of the snare drum stored in the first audio library as well as tempos and time signatures corresponding to the drumbeat sub-audios, according to the embodiments of the present disclosure, are listed in Table 2 below.

TABLE 2

| Time signature | Tempo | Audio data identifier |
|---|---|---|
| 4/4 beat | 60 beats/minute | A1 |
| 4/4 beat | 30 beats/minute | A2 |
| 4/4 beat | 80 beats/minute | A3 |
| 3/4 beat | 60 beats/minute | A4 |
| 3/4 beat | 30 beats/minute | A5 |
| 3/4 beat | 80 beats/minute | A6 |

Based on Table 2, in the case that the time signature is 4/4 beat and the tempo is 60 beats/minute, the audio data identifier corresponding to the drumbeat sub-audio is A1. In the case that the time signatures and the tempos are other values, the audio data identifiers corresponding to the drumbeat sub-audios are listed in Table 2, which is not repeated herein.

It should be noted that different audio data identifiers correspond to different drumbeat sub-audios. For example, in the case that the audio data identifier is A1, the corresponding drumbeat sub-audio is an audio that has four beats with a time interval of one second between each beat. In the case that the audio data identifier is A2, the corresponding drumbeat sub-audio is an audio that has 4 beats with a time interval of two seconds between each beat.

It should also be noted that the above Table 2 is only an example of correspondences between audio data identifiers corresponding to drumbeat sub-audios and tempos and time signatures corresponding to the drumbeat sub-audios provided by the embodiments of the present disclosure, which does not intend to constitute any limitation to the first audio library. The first audio library includes drumbeat sub-audios corresponding to various drumbeat instruments at various time signatures and various tempos.

For example, it is determined that the drumbeat instrument is a snare drum, the target music has a tempo of 60 beats/minute and has a time signature of 4/4 beat. A plurality of drumbeat sub-audios corresponding to the snare drum are determined from the first audio library. An audio data identifier of a drumbeat sub-audio corresponding to the tempo and the time signature of the target music among the plurality of drumbeat sub-audios is determined as the audio data identifier corresponding to the drumbeat sub-audio included in the music score data. That is, the audio data identifier A1 is determined as the audio data identifier corresponding to the drumbeat sub-audio included in the music score data of the target music.

In some embodiments, the process of determining the performance time information corresponding to the drumbeat sub-audio based on the time signature and the tempo of the target music includes: determining the total number of beats in the target music based on the tempo and a duration of the target music; determining the number of music measures included in the target music based on the time signature of the target music and the total number of beats in the target music; determining performance time information corresponding to each of the music measures based on the number of music measures included in the target music and the time signature of the target music; and determining the performance time information corresponding to each of the music measures as the performance time information corresponding to the drumbeat sub-audio.

For example, in the case that the target music has a tempo of 60 beats/minute and a duration of 1 minute, the total number of beats included in the target music is 60 beats, and the time signature of the target music is 4/4 beat. Then, based on the time signature of the target music and the total number of beats included in the target music, it is determined that there are 15 music measures included in the target music. Each of these music measures includes 4 beats and there are a total of 15 music measures, and thus performance time information corresponding to each music measure is determined. Then, the performance time information corresponding to each music measure is determined as the performance time information corresponding to the drumbeat sub-audio.

For example, the description is given by taking a scenario in which the target music has a tempo of 60 beats per minute, a time signature of 4/4 beat, and a duration of 1 minute, and the performance time information includes a start beat and a duration beat as an example. In this case, the total number of beats included in the target music is 60, the number of music measures included in the target music is 15, and the performance time information corresponding to each of the music measures is (1, 4), (5, 8), (9, 12), (13, 16), (17, 20), (21, 24), (25, 28), (29, 32), (33, 36), (37, 40), (41, 44), (45, 48), (49, 52), (53, 56), (57, 60). Therefore, the performance time information corresponding to the drumbeat sub-audio is (1, 4), (5, 8), (9, 12), (13, 16), (17, 20), (21, 24), (25, 28), (29, 32), (33, 36), (37, 40), (41, 44), (45, 48), (49, 52), (53, 56), (57, 60).

In some embodiments, the process of determining the audio data identifier and the performance time information corresponding to the chord sub-audio based on the tempo, the time signature, and the chord list of the target music includes based on the tempo and the time signature of the target music, determining an audio data identifier corresponding to the chord identifier; and determining the performance time information and the audio data identifier corresponding to the chord identifier as the performance time information and the audio data identifier corresponding to the chord sub-audio.

In some embodiments, a chord instrument needs to be determined prior to acquiring the audio data identifier and the performance time information corresponding to the chord sub-audio. The chord instrument is manually determined by designating a chord instrument among a plurality of chord instruments, or randomly determined by a computer device, which is not limited herein. It should be noted that whether the chord instrument is manually designated or randomly determined by the computer device, an instrumental timbre of the chord instrument determined by the above methods is matched with the hearing-impaired hearing timbre.

For example, the chord instrument as determined is a bass.

In some embodiments, a second audio library is pre-stored in the computer device. A plurality of chord sub-audios are stored in the second audio library, and the plurality of chord sub-audios stored in the second audio library correspond to instrumental timbres that are matched with the hearing-impaired hearing timbre. Each of the chord sub-audios in the second audio library corresponds to an audio data identifier.

The chord sub-audio stored in the second audio library is an audio clip in an MP3 format or is an audio clip in another format, which is not limited herein.

Correspondences between audio data identifiers corresponding to chord sub-audios of the bass stored in the second audio library, and tempos, time signatures, and chord identifiers corresponding to the chord sub-audios according to the embodiments of the present disclosure are listed in Table 3.

TABLE 3

| | | | Audio data |
|---|---|---|---|
| Chord identifier | Time signature | Tempo | identifier |
| Chord A | 4/4 beat | 60 beats/minute | B1 |
| | 4/4 beat | 30 beats/minute | B2 |
| | 3/4 beat | 80 beats/minute | B3 |
| Chord C | 4/4 beat | 60 beats/minute | C1 |
| | 4/4 beat | 30 beats/minute | C2 |
| | 3/4 beat | 80 beats/minute | C3 |
| Chord A | 4/4 beat | 60 beats/minute | D1 |
| | 4/4 beat | 30 beats/minute | D2 |
| | 3/4 beat | 80 beats/minute | D3 |
| Chord C | 4/4 beat | 60 beats/minute | E1 |
| | 4/4 beat | 30 beats/minute | E2 |

Based on Table 3, in the case that the time signature is 4/4 beat and the tempo is 60 beats/minute, an audio data identifier corresponding to a chord sub-audio of the chord A is B1. In the case that time signatures and the tempos are other values, audio data identifiers corresponding to the chord sub-audios of the chord A are listed in Table 3, which are not repeated herein.

It should be noted that different audio data identifiers correspond to different chord sub-audios. For example, A chord sub-audio corresponding to the audio data identifier B1 is an audio of the chord A of 4 beats with a time interval of one second between each beat. A chord sub-audio corresponding to the audio data identifier B2 is an audio of the chord A of 4 beats with a time interval of two seconds between each beat

It should also be noted that Table 3 above is only an example table of the correspondence between the chord identifier, the tempo, the time signature, and the audio data identifier according to the embodiments of the present disclosure, and does not intend to constitute any limitation to the second audio library. The second audio library includes chord sub-audios of various chord identifiers corresponding to various chord instruments at various time signatures and various tempos.

In some embodiments, the performance time information corresponding to the chord identifier already exists in the chord list of the target music, and the audio data identifier corresponding to the chord identifier is determined based on Table 3 above. Therefore, the performance time information and audio data identifier corresponding to the chord identifier are determined as the performance time information and audio data identifier corresponding to the chord sub-audio included in the music score data.

For example, taking a scenario where the target music has a tempo of 60 beats/minute, a time signature of 4/4 beat, and a duration of 1 minute as an example, based on the above-described process, the acquired music score data corresponding to the target music are listed in Table 4 below.

TABLE 4

| Performance time information | Audio data identifier |
|---|---|
| corresponding to sub-audio | corresponding to sub-audio |
| (1, 4) | A1 |
| (5, 8) | A1 |
| (9, 12) | A1, B1 |
| (13, 16) | A1, E1 |
| (17, 20) | A1, C1 |
| (21, 24) | A1, B1 |
| . . . | . . . |
| (57, 60) | A1, H1 |

As can be seen from Table 4, from the first beat to the fourth beat, the sub-audio is a drumbeat sub-audio corresponding to the audio data identifier A1, from the fifth beat to the eighth beat, the sub-audio is a drumbeat sub-audio corresponding to the audio data identifier A1, and from the ninth beat o the twelfth beat, the sub-audio is a drumbeat sub-audio corresponding to the audio data identifier A1 and a chord sub-audio corresponding to the audio data identifier B1. Audio data identifiers of sub-audios corresponding to other performance time information are listed in Table 4 above, which are not repeated herein.

In some embodiments, the music score data of the target music is acquired by a user who has musicianship based on a MIDI file of the target music. That is, the audio data identifier and the performance time information corresponding to the drumbeat sub-audio, and/or, the audio data identifier and the performance time information corresponding to the chord sub-audio, are determined by the user based on the MIDI file of the target music, and the music score data of the target music is acquired by the computer device in response to an input operation of the user in the computer device.

In step 202, the sub-audios are acquired based on the audio data identifiers corresponding to each of the sub-audios.

In some embodiments, after the audio data identifiers corresponding to the plurality of sub-audios are determined based on step 201, the sub-audio corresponding to each of the audio data identifiers is extracted from the audio library based on the audio data identifier corresponding to each of the sub-audios.

In some embodiments, the drumbeat sub-audio corresponding to the audio data identifier of the drumbeat sub-audio is extracted from the first audio library. For example, the drumbeat sub-audio corresponding to the audio data identifier A1 is extracted from the first audio library. The chord sub-audio corresponding to the audio data identifier of the chord sub-audio is extracted from the second audio library. For example, the chord sub-audio corresponding to the audio data identifier B1 is extracted from the second audio library.

In some embodiments, in the case that the number of beats included in performance time information corresponding to a first audio data identifier is less than one music measure, a sub-audio corresponding to the first audio data identifier is acquired from the audio library, and a sub-audio of the performance time information corresponding to the first audio data identifier is acquired by intercepting in the sub-audio corresponding to the first audio data identifier in accordance with the number of beats included in the performance time information corresponding to the first audio data identifier, wherein the number of beats of the sub-audio of the performance time information corresponding to the first audio data identifier is consistent with the number of beats included in the performance time information corresponding to the first audio data identifier.

For example, the first audio data identifier is B1, the performance time information corresponding to the first audio data identifier is (5, 7) beat, and the number of beats is 3. Therefore, a sub-audio with the audio data identifier B1 is acquired from the audio library, and 3/4 of the sub-audio with the audio data identifier B1 is intercepted. In this way, a sub-audio corresponding to the audio data identifier B1 in (5, 7) beat is acquired.

In step 203, a synthetic audio of the target music is generated by performing a fusion process on the sub-audios based on the performance time information corresponding to each of the sub-audios.

In some embodiments, an intermediate audio of the target music is acquired by performing the fusion process on the sub-audios based on the performance time information corresponding to each of the sub-audios, and the intermediate audio of the target music is determined as the synthetic audio of the target music.

There are the following two cases to acquire the intermediate audio of the target music by performing the fusion process on the sub-audios based on the performance time information corresponding to each of the sub-audios.

In the first case, in response to the fact that the performance time information of the sub-audios is not coincident, the intermediate audio of the target music is acquired by splicing the plurality of sub-audios based on the performance time information corresponding to each of the sub-audios.

The drumbeat sub-audio is required to be present throughout the music. Therefore, in the case that the performance time information of the sub-audios is not coincident, it is indicated that the target music includes only the drumbeat sub-audio without the chord sub-audio, or includes only the chord sub-audio without the drumbeat sub-audio, and each of the performance time information corresponds to only one chord sub-audio.

In some embodiments, when acquiring the intermediate audio of the target music by splicing the plurality of sub-audios, it is possible to acquire a plurality of sub-audios subjected to a fade-in and fade-out process by performing the fade-in and fade-out process on the sub-audios separately, and then acquire the intermediate audio of the target music by splicing the plurality of sub-audios subjected to the fade-in and fade-out process. The purpose of the fade-in and fade-out process is to make the intermediate audio acquired by splicing not distorted, such that the intermediate audio is more coherent.

The process of performing the fade-in and fade-out process on the sub-audio includes: performing a fade-in process on a header of the sub-audio, performing a fade-out process on a trailer of the sub-audio, and acquiring the sub-audio subjected to the fade-in and fade-out process.

The fade-in process and the fade-out process need to be performed for the same duration, and the durations of the fade-in process and the fade-out process are not limited herein. For example, in the case that the duration of the fade-in process and the fade-out process is 50 milliseconds, the fade-in process is performed on the first 50 milliseconds of the sub-audio, and the fade-out process is performed on the last 50 milliseconds of the sub-audio.

For example, the target music includes only the drumbeat sub-audios, and the performance time information corresponding to the drumbeat sub-audios is (1, 4), (5, 8), (9, 12), and (13, 16). The drumbeat sub-audios subjected to the fade-in and fade-out process are acquired by performing the fade-in and fade-out process on the drumbeat sub-audios. The intermediate audio of the target music is acquired by splicing the drumbeat sub-audios subjected to the fade-in and fade-out process four times. The intermediate audio includes four segments of drumbeat sub-audios subjected to the fade-in and fade-out process.

In some embodiments, when splicing the plurality of drumbeat sub-audios subjected to the fade-in and fade-out process, two adjacent sub-audios are also crossfaded. That is, a trailer of the sub-audio at the front position is cross-mixed with a header of the sub-audio at the back position, thereby acquiring the intermediate audio of the target music. The duration of the cross-mixing portion of the two adjacent sub-audios is an arbitrary value, which is not limited herein. For example, the duration of the cross-mixing portion of the two adjacent sub-audios is 200 milliseconds. That is, the last 200 milliseconds of the sub-audio at the front position and the first 200 milliseconds of the sub-audio at the back position are cross-mixed together.

In the second case, in response to the same performance time information corresponding to at least two first sub-audios, a second sub-audio is acquired by performing an audio mixing process on the at least two first sub-audios. Performance time information corresponding to the second sub-audio is identical to the performance time information corresponding to the at least two first sub-audios. Further, a second sub-audio subjected to the fade-in and fade-out process and a third sub-audio subjected to the fade-in and fade-out process are acquired by preforming the fade-in and fade-out process separately on the second sub-audio and the third sub-audio. The third sub-audio is a sub-audio whose performance time information is different from the performance time information corresponding to the second sub-audio. In accordance with the performance time information corresponding to the second sub-audio and the performance time information corresponding to the third sub-audio, the intermediate audio of the target music is acquired by splicing the second sub-audio subjected to the fade-in and fade-out process and the third sub-audio subjected to the fade-in and fade-out process.

For example, the target music has a total of eight beats, with drumbeat sub-audios present from the first beat to the fourth beat and from the fifth beat to the eight beat, and a chord sub-audio present from the fifth beat to the eighth beat. Therefore, a second sub-audio, which corresponds to the performance time information (5, 8), is acquired by performing the audio mixing process on the drumbeat sub-audios from the fifth beat to the eighth beat and the chord sub-audio from the fifth beat to the eighth beat. Then, a drumbeat sub-audio, from the first beat to the fourth beat, subjected to the fade-in and fade-out process is acquired by performing the fade-in and fade-out process on the drumbeat sub-audio from the first beat to the fourth beat, and a second sub-audio, from the fifth beat to the eighth beat, subjected to the fade-in and fade-out process is acquired by performing the fade-in and fade-out process on the second sub-audio from the fifth beat to the eighth beat. Further, the intermediate audio of the target music is acquired by splicing the drumbeat sub-audio, from the first beat to the fourth beat, subjected to the fade-in and fade-out process and the second sub-audio, from the fifth beat to the eighth beat, subjected to the fade-in and fade-out process.

In some embodiments, when splicing the second sub-audio subjected to the fade-in and fade-out process and the third sub-audio subjected to the fade-in and fade-out process, a cross-fade process is also performed on any two adjacent sub-audios of the fade-processed second sub-audio and the fade-processed third sub-audio. The cross-fade process is illustrated in the first case as described above, which is not repeated herein.

In some embodiments, after acquiring the intermediate audio of the target music, an ambient sound is also added to the intermediate audio to acquire the intermediate audio with the added ambient sound, and the intermediate audio with the added ambient sound is determined as the synthetic audio of the target music.

A third audio library is stored in the computer device, and various types of ambient sounds are stored in the third audio library, such as rain sounds, cicada sounds, coastal sounds, and the like. The ambient sounds stored in the third audio library are in any duration, which is not limited herein. The ambient sound stored in the third audio library is a sound that can be heard by hearing-impaired people. The ambient sound stored in the third audio library is an audio clip in an MP3 format, or an audio clip in another format, which is not limited herein.

Typically, the ambient sound is added at the beginning of the music, but of course, the ambient sound is also added at other positions of the musical composition. The type of the added ambient sound, as well as the position where the ambient sound is added, are manually set, which is not limited herein.

In some embodiments, when adding the target ambient sound to a target position of the target music, whether the duration of the target ambient sound is consistent with a duration corresponding to the target position needs to be determined. In the case that the duration of the target ambient sound is inconsistent with the duration corresponding to the target position, the target ambient sound is first interpolated/de-framed, such that the duration of the interpolated/de-framed target ambient sounds is consistent with the duration corresponding to the target position. Then, a target audio of the target position is acquired by performing the audio mixing process on the interpolated/de-framed target ambient sound and an audio of the target position. The synthetic audio of the target music is acquired by splicing the target audio of the target position and audios of the intermediate audio other than the audio of the target position.

In the case that the duration of the target ambient sound is consistent with the duration corresponding to the target position, the target ambient sound is mixed with the audio of the target position to acquire the target audio of the target position, and then the synthetic audio of the target music is acquired by splicing the target audio of the target position with audios in the intermediate audio other than the audio of the target position.

For example, in the case that an ambient sound of “rain” needs to be added to the intermediate audio of the target music from the 0th to the 3rd second and the duration of the ambient sound of “rain” is 2 seconds, then the ambient sound of “rain” needs to be interpolated first, and the interpolated ambient sound of “rain” is acquired after the interpolation process. The duration of the interpolated ambient sound of “rain” is 3 seconds. The target audio from the 0th to the 3rd second is acquired by performing the audio mixing process on the interpolated ambient sound of “rain” and the audio from the 0th to the 3rd second of the intermediate audio of the target music. Then, the synthetic audio of the target music is acquired by splicing the target audio from the 0th to the 3rd second and audios in the intermediate audio other than the audio from the 0th to the 3rd second.

In some embodiments, the synthetic audio of the target music is acquired by performing a frequency domain compression process on the intermediate audio of the target music.

In some embodiments, the process of acquiring the synthetic audio of the target music by performing the frequency domain compression process on the intermediate audio of the target music includes: acquiring a first sub-audio of a first frequency domain interval corresponding to the intermediate audio and a second sub-audio of a second frequency domain interval corresponding to the intermediate audio, wherein a frequency of the first frequency domain interval is less than a frequency of the second frequency domain interval; acquiring a third sub-audio by performing gain compensation on the first sub-audio based on a first gain coefficient; acquiring a fourth sub-audio by performing gain compensation on the second sub-audio based on a second gain coefficient; acquiring a fifth sub-audio by performing a compression frequency shift process on the fourth sub-audio, wherein a lower limit of a third frequency interval corresponding to the fifth sub-audio is equal to a lower limit of a second frequency interval; and acquiring the synthetic audio of the target music by performing the fusion process on the third sub-audio and the fifth sub-audio.

The first sub-audio in the first frequency interval and the second sub-audio in the second frequency interval are acquired by analyzing the intermediate audio based on an analysis filter in a quadrature mirror filter bank or based on a frequency divider. The first sub-audio and the second sub-audio are acquired in other ways, which are not limited herein.

Each frequency interval includes one or more frequency bands, and each frequency band corresponds to a gain coefficient. Based on the gain coefficient corresponding to each frequency band, a decibel compensation value corresponding to each frequency band is determined. An audio of the gain-compensated frequency band is acquired by performing, based on the decibel compensation value corresponding to each frequency band, a gain compensation on the audio of each frequency band.

For example, the first frequency interval is from 0 to 1000 Hz, the first frequency interval includes only one frequency band, and a gain coefficient corresponding to the frequency band from 0 to 1000 Hz is 2. Based on the gain coefficient of 2 corresponding to the frequency band from 0 to 1000 Hz, a decibel compensation value corresponding to the frequency band from 0 to 1000 Hz is determined. Then, the third sub-audio is acquired by performing a gain compensation on the first sub-audio based on the decibel compensation value corresponding to the frequency band from 0 to 1000 Hz.

As another example, the second frequency interval is from 1000 to 8000 Hz, and the second frequency interval includes three frequency bands, namely: a first frequency band of 1000 to 2000 Hz, a second frequency band of 2000 to 4000 Hz, and a third frequency band of 4000 to 8000 Hz. The first frequency band corresponds to a gain coefficient of 2.5, the second frequency band corresponds to a gain coefficient of 3, and the third frequency band corresponds to a gain coefficient of 3.5. Therefore, a decibel compensation value corresponding to the first frequency band is determined based on the gain coefficient corresponding to the first frequency band, a decibel compensation value corresponding to the second frequency band is determined based on the gain coefficient corresponding to the second frequency band, and a decibel compensation value corresponding to the third frequency band is determined based on the gain coefficient corresponding to the third frequency band. The gain compensation is performed on the audio of the first frequency band based on the decibel compensation value corresponding to the first frequency band, on the audio of the second frequency band based on the decibel compensation value corresponding to the second frequency band, and on an audio of the third frequency band based the decibel compensation value corresponding to the third frequency band, such that the fourth sub-audio is acquired.

In some embodiments, the process of acquiring the fifth sub-audio by performing the compression frequency shift process on the fourth sub-audio includes: acquiring a sixth sub-audio by performing a frequency compression of a target ratio on the fourth sub-audio, and acquiring the fifth sub-audio by performing a frequency upshift of a target value on the sixth sub-audio, wherein the target value is equal to a difference between the lower limit of the second frequency interval and a lower limit of a fourth frequency interval corresponding to the sixth sub-audio.

As there is an overlap between the frequency interval of the sixth sub-audio acquired by performing the frequency compression of the target ratio on the fourth sub-audio and the first frequency interval corresponding to the third sub-audio, it is necessary to perform the frequency upshift of the target value on the sixth sub-audio to acquire the fifth sub-audio. In this way, there is no overlap between a frequency interval corresponding to the fifth sub-audio and the first frequency interval corresponding to the third sub-audio, such that the subsequent synthetic audio sounds better.

The target ratio is any value, which is not limited herein. For example, the target ratio is 50%.

For example, in the case that the target ratio is 50% and the second frequency interval corresponding to the fourth sub-audio is from 1000 to 8000 Hz, the sixth sub-audio is acquired by performing the frequency compression of the target ratio on the fourth sub-audio, and the sixth sub-audio corresponds to the fourth frequency interval of 500 to 4000 Hz. Based on the lower limit of the fourth frequency interval and the lower limit of the second frequency interval, it is determined that the target value is 500, and therefore, the fifth sub-audio is acquired by shifting the frequency of the sixth sub-audio upward by 500 Hz. The third frequency interval corresponding to the fifth sub-audio is from 1000 to 4500 Hz.

In some embodiments, ways of acquiring the synthetic audio of the target music by performing the fusion process on the third sub-audio and the fifth sub-audio include, but are not limited to, acquiring the synthetic audio of the target music by processing the third sub-audio and the fifth sub-audio through a synthesis filter of the quadrature mirror filter bank, or acquiring the synthetic audio of the target music by performing the audio mixing process on the third sub-audio and the fifth sub-audio.

Performing the audio mixing process on the third sub-audio and the fifth sub-audio is prone to the problem of sound cracking. Therefore, the synthetic audio of the target music is acquired by using a compressor to process the audio after mixing the third sub-audio and the fifth sub-audio.

In some embodiments, after acquiring the synthetic audio of the target music, it is also possible to play the synthetic audio of the target music, which is heard by hearing-impaired people. In response to receiving an instruction from hearing-impaired people to modify the timbre of the target sub-audio in the synthetic audio, an interaction page is displayed, with a drumbeat control, a chord control, and an ambient sound control displayed on the interaction page. In response to receiving a select instruction for any of the controls, a plurality of sub-controls included in the control are displayed, each of the sub-controls corresponding to one sub-audio. In response to a select instruction for any of the plurality of sub-controls, a sub-audio corresponding to the selected sub-control is played. In response to receiving a confirmed instruction of the selected sub-control, the target sub-audio is replaced with the sub-audio corresponding to the selected sub-control, and thus a modified synthetic audio of the target music is acquired.

For example, in response to a select instruction for the drumbeat control, drumbeat sub-controls are displayed, each of the drumbeat sub-controls corresponding to a drumbeat sub-audio. In response to a select instruction for any one of the plurality of drumbeat sub-controls, the drumbeat sub-audio corresponding to the selected drumbeat sub-control is played. In response to receiving a confirm of the selected drumbeat sub-control, the target sub-audio is replaced with the sub-audio corresponding to the selected drumbeat sub-control, and thus the modified synthetic audio of the target music is acquired.

The above-described method re-scores the target music, and the instrumental timbre of the sub-audio used in the scoring is matched with the hearing-impaired hearing timbre, such that hearing-impaired people are capable of hearing the sub-audio used in the scoring. Then the synthetic audio of the target music is acquired based on the sub-audio, such that hearing-impaired people, when listening to the synthetic audio of the target music, do not suffer from the problem of being intermittent and occasionally inaudible, and there is also no distortion. In this way, hearing-impaired people hear smooth music, which makes the listening experience of hearing-impaired people better, and the problem of poor sound quality and poor listening effect of hearing-impaired people when listening to music is addressed from the root.

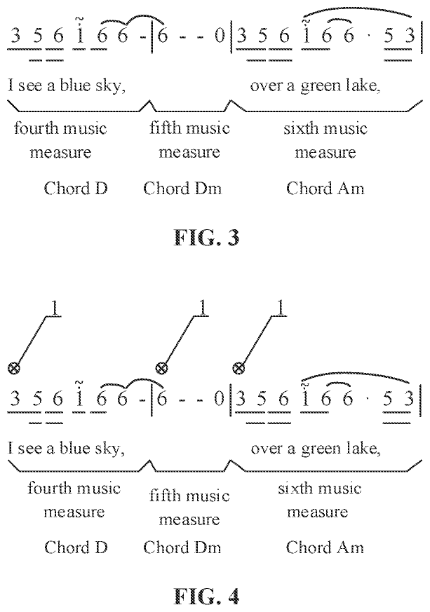

A song typically has a long duration and contains a large number of music measures and a large number of beats. Therefore, the description is given herein by taking a scenario where the fourth, fifth, and sixth music measures of the song “Haven” are the target music as an example to illustrate the process of acquiring the synthetic audio of the target music. A numbered musical notion of the fourth, the fifth, and the sixth music measures of the song “Heaven” is illustrated in FIG. 3.

An electronic music score of the target music is acquired, and a tempo, a time signature, and a chord list of the target music are acquired by inputting the electronic music score into a score analysis tool. The tempo of the target music is 70 beats/minute, the time number is 4/4 beat, and the chord list is listed in Table 5 below.

TABLE 5

| Performance time information | Chord identifier |
|---|---|
| (13, 16) | Chord D |
| (17, 20) | Chord Dm |
| (21, 24) | Chord Am |

An instrument timbre of a drumbeat sub-audio used in the synthetic audio of the target music is preset to be a drum, and the instrument timbre of a chord sub-audio is rock bass. The target music has a tempo of 70 and a time signature of 4/4, and therefore, an audio data identifier N1 is determined in the first audio library, and a drumbeat sub-audio corresponding to the audio data identifier N1 is determined as a drumbeat sub-audio in the synthetic audio. Based on the tempo, the time signature, and the chord list of the target music, audio data identifiers M1, M2, and M3 are determined in the second audio library, wherein the audio data identifier M1 corresponds to a chord sub-audio of the chord D, the audio data identifier M2 corresponds to a chord sub-audio of the chord Dm, and the audio data identifier M3 corresponds to a chord sub-audio of the chord Am. The chord sub-audios corresponding to the audio data identifiers M1, M2, and M3 are determined as chord sub-audios in the synthetic audio. In this way, the music score data of the target music is acquired and is listed in Table 6 below.

TABLE 6

| Performance time information | Audio data identifier |
|---|---|
| corresponding to sub-audio | corresponding to sub-audio |
| (13, 16) | N1, M1 |
| (17, 20) | N1, M2 |
| (21, 24) | N1, M3 |

Next, the drumbeat sub-audio with the audio data identifier N1 is extracted from the first audio library, and the chord sub-audios respectively with the audio data identifiers M1, M2, and M3 are extracted from the second audio library. Both the drumbeat sub-audio and the chord sub-audio are present in the performance time information (13, 16), (17, 20), and (21, 24). Therefore, it is necessary to mix the drumbeat sub-audio and the chord sub-audio corresponding to each of the performance time information to acquire a mixed sub-audio corresponding to each of the performance time information, i.e., to acquire a first mixed sub-audio, a second mixed sub-audio, and a third mixed sub-audio.

The first mixed sub-audio is acquired based on the drumbeat sub-audio with the audio data identifier N1 and the chord sub-audio with the audio data identifier M1, and the performance time information of the first mixed sub-audio is (13, 16). The second mixed sub-audio is acquired based on the drumbeat sub-audio with the audio data identifier N1 and the chord sub-audio with the audio data identifier M2, and the performance time information of the second mixed sub-audio is (17, 20). The third mixed sub-audio is acquired based on the drumbeat sub-audio with the audio data identifier N1 and the chord sub-audio with the audio data identifier M3, and the performance time information of the third remixed sub-audio is (21, 24).

Afterward, the remix sub-audios subjected to the fade-in and fade-out process are acquired by performing the fade-in/fade-out process on the respective remix sub-audios, and immediately thereafter, an intermediate audio of the target music is acquired by splicing two remixed sub-audios whose performance time information is adjacent in the remixed sub-audios subjected to the fade-in and fade-out process.

In some embodiments, when splicing the two remixed sub-audios with adjacent performance time information, the intermediate audio of the target music is acquired by performing a cross-fade process on the two remixed sub-audios to be spliced.

In some embodiments, the intermediate audio of the target music is determined as the synthetic audio of the target music. A numbered musical notion corresponding to the synthetic audio of the fourth, the fifth, and the sixth music measures of the song “Heaven” generated after the above processing is illustrated in FIG. 4. The marker numbered 1 indicates a drum beat, and one drum beat exists for each music measure, located on the first beat of the music measure.

In some embodiments, a first sub-audio and a second sub-audio are acquired by analyzing the intermediate audio of the target music. A third sub-audio is acquired by performing a gain compensation on the first sub-audio, and a fourth sub-audio is acquired by performing a gain compensation on the second sub-audio. A sixth sub-audio is acquired by compressing the frequency of the fourth sub-audio by 50%. A fifth sub-audio is acquired by shifting the frequency of the sixth sub-audio up 500 Hz. Further, based on the third sub-audio and the fifth sub-audio, the synthetic audio of the target music is acquired.

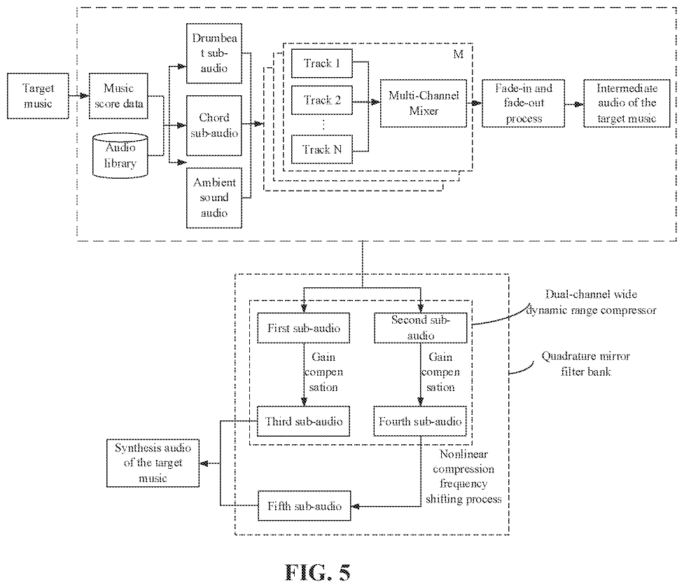

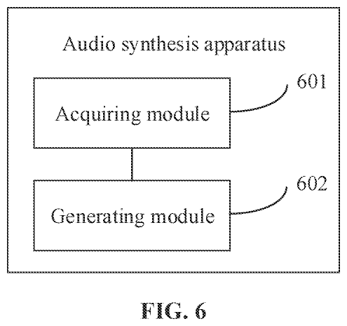

FIG. 5 is a flowchart of an audio synthesis method according to some embodiments of the present disclosure. In FIG. 5, target music is acquired, and music score data of the target music is acquired by analyzing the target music. Based on the music score data of the target music and pre-stored audio libraries (the audio libraries include a first audio library, a second audio library, and a third audio library, with a plurality of drumbeat sub-audios stored in the first audio library, a plurality of chord sub-audios stored in the second audio library, and a plurality of ambient sound audios stored in the third audio library), drumbeat sub-audios, chord sub-audios, and ambient sound audios included in the target music are determined. Because a situation where at least two sub-audios are present in the same performance time information occurs, it is necessary to perform an audio mixing process on the at least two sub-audios that are present in the same performance time information. For example, there exists a track 1, a track 2, . . . a track N for the Mth performance time information in FIG. 5, wherein each of the track 1, the track 2, and the track N corresponds to a sub-audio. In this case, a mixed sub-audio is acquired by performing, based on a multi-channel mixer, the audio mixing process on the sub-audios respectively corresponding to the track 1, the track 2, and the track N. Then, a sub-audio that has undergone the fade-in and fade-out process is acquired by performing a fade-in and fade-out process on the mixed sub-audio and other sub-audios in the plurality of sub-audios except for the sub-audios with the same performance time information. The intermediate audio of the target music is acquired by then splicing the mixed sub-audio that has undergone the fade-in and fade-out process and the other sub-audios that have undergone the fade-in and fade-out process.

At this point, the intermediate audio of the target music is determined as the synthetic audio of the target music. Alternatively, the synthetic audio of the target music is acquired by further processing the intermediate audio of the target music.

The process of further processing includes: acquiring a first sub-audio and a second sub-audio within a quadrature mirror filter bank; acquiring a third sub-audio by performing a gain compensation on the first sub-audio and acquiring a fourth sub-audio by performing a gain compensation on the second sub-audio, within a dual-channel wide dynamic range compressor; acquiring a fifth sub-audio by performing a nonlinear compression frequency shifting process on the fourth sub-audio; and acquiring the synthetic audio of the target music based on the third sub-audio and the fifth sub-audio.

FIG. 6 is a schematic structural diagram of an audio synthesis apparatus according to some embodiments of the present disclosure. As illustrated in FIG. 6, the apparatus includes:
an acquiring module 601, configured to acquire music score data of target music, wherein the music score data includes audio data identifiers and performance time information corresponding to a plurality of sub-audios, an instrumental timbre corresponding to each of the sub-audios being matched with a hearing-impaired hearing timbre;
the acquiring module 601, further configured to acquire the sub-audios based on the audio data identifiers corresponding to each of the sub-audios; and
a generating module 602, configured to generate a synthetic audio of the target music by performing a fusion process on the sub-audios based on the performance time information corresponding to each of the sub-audios.

In some embodiments, in a frequency spectrum of an instrument corresponding to each of the sub-audios, a ratio of energy of a low-frequency band to energy of a high-frequency band is greater than a ratio threshold. The low-frequency band is a band lower than a frequency threshold, and the high-frequency band is a band higher than the frequency threshold. The ratio threshold indicates a condition that the ratio of the energy of the low-frequency band to the energy of the high-frequency band in a frequency spectrum of an audio which is capable of being heard by hearing-impaired people needs to be satisfied.

In some embodiments, the acquiring module 601 is configured to determine the audio data identifiers and the performance time information corresponding to the plurality of sub-audios based on a tempo, a time signature, and a chord list of the target music.

In some embodiments, the plurality of sub-audios include a drumbeat sub-audio and a chord sub-audio.

The acquiring module 601 is configured to determine, based on the tempo and the time signature of the target music, an audio data identifier and performance time information corresponding to the drumbeat sub-audio;
determine, based on the tempo, the time signature, and the chord list of the target music, an audio data identifier and performance time information corresponding to the chord sub-audio; and
acquire the audio data identifiers and the performance time information corresponding to the plurality of sub-audios by composing the audio data identifier and the performance time information corresponding to the drumbeat sub-audio and the audio data identifier and the performance time information corresponding to the chord sub-audio.

In some embodiments, the acquiring module 601 is configured to determine an audio data identifier corresponding to the time signature and the tempo of the target music and determine the audio data identifier corresponding to the time signature and the tempo of the target music as the audio data identifier corresponding to the drumbeat sub-audio; and determine, based on the time signature and the tempo of the target music, the performance time information corresponding to the drumbeat sub-audio.

In some embodiments, the chord list includes a chord identifier and performance time information corresponding to the chord identifier.

The acquiring module 601 is configured to determine, based on the tempo and the time signature of the target music, an audio data identifier corresponding to the chord identifier; and
determine the performance time information and the audio data identifier corresponding to the chord identifier as the performance time information and the audio data identifier corresponding to the chord sub-audio.

In some embodiments, the generating module 602 is configured to acquire an intermediate audio of the target music by performing a fusion process on the sub-audios based on the performance time information corresponding to each of the sub-audios; and acquire a synthetic audio of the target music by performing a frequency domain compression process on the intermediate audio of the target music.

In some embodiments, the synthesizing module 602 is configured to acquire a first sub-audio of a first frequency interval corresponding to the intermediate audio and a second sub-audio of a second frequency interval corresponding to the intermediate audio, wherein a frequency of the first frequency interval is less than a frequency of the second frequency interval;
acquire a third sub-audio by performing a gain compensation on the first sub-audio based on a first gain coefficient, and acquire a fourth sub-audio by performing a gain compensation on the second sub-audio based on a second gain coefficient;
acquire a fifth sub-audio by performing a compression frequency shifting process on the fourth sub-audio, wherein a lower limit of a third frequency interval corresponding to the fifth sub-audio is equal to a lower limit of the second frequency interval; and
acquire the synthetic audio of the target music by performing a fusion process on the third sub-audio and the fifth sub-audio.

In some embodiments, the generating module 602 is configured to acquire a sixth sub-audio by performing a frequency compression of a target ratio on the fourth sub-audio; and acquire a fifth sub-audio by performing a frequency upshift of a target value on the sixth sub-audio, wherein the target value is equal to a difference between the lower limit of the second frequency interval and a lower limit of a fourth frequency interval corresponding to the sixth sub-audio.

The above-described apparatus re-scores the target music, and the instrumental timbre of the sub-audio used in the scoring matches the hearing-impaired hearing timbre, such that hearing-impaired people are capable of hearing the sub-audio used in the scoring. Then the synthetic audio of the target music is acquired based on the sub-audio, such that hearing-impaired people, when listening to the synthetic audio of the target music, do not suffer from the problem of being intermittent and occasionally inaudible, and there is also no distortion. In this way, hearing-impaired people hear smooth music, which makes the listening experience of hearing-impaired people better, and the problem of poor sound quality and poor listening effect of hearing-impaired people when listening to music is addressed from the root.

It should be noted that: for the apparatus according to FIG. 6, description is only given to the above division of the functional modules. The above functions of the apparatus may be distributed to different functional modules according to actual needs. That is, an internal structure of the apparatus is divided into different functional modules to implement a part or all of the functions as described above. In addition, the apparatus according to the above embodiments is based on the same concept as the method embodiments as described above, and the specific implementation process of the apparatus is detailed in the method embodiments, which is not repeated herein.

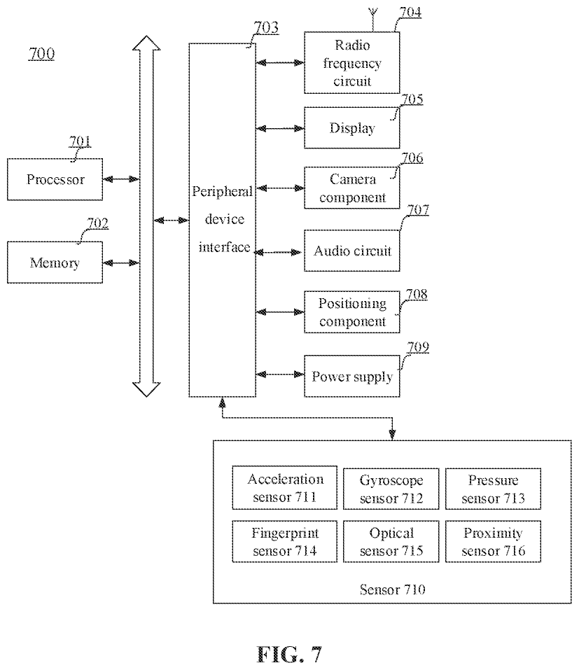

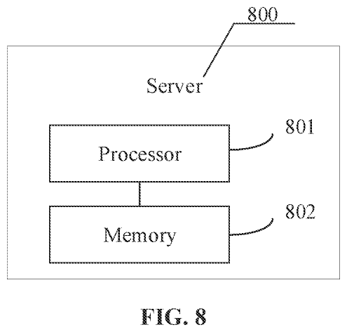

FIG. 7 is a schematic structural diagram of a terminal device according to some embodiments of the present disclosure. The terminal device 700 is a portable mobile terminal, such as a smartphone, a tablet computer, a moving picture experts group audio layer III (MP3) player, a moving picture experts group audio layer IV (MP4) player, a laptop computer, or a desktop computer. The terminal device 700 is also referred to as a user device, a portable terminal, a laptop terminal, a desktop terminal, and other names.

Typically, the terminal device 700 includes a processor 701 and a memory 702.

The processor 701 includes one or more processing cores, such as a 4-core processor, an 8-core processor, and the like. The processor 701 is implemented by using at least one hardware form of a digital signal processing (DSP), a field-programmable gate array (FPGA), and a programmable logic array (PLA). The processor 701 also includes a main processor and a co-processor. The main processor is a processor, also referred to as a central processing unit (CPU), configured to process data in a wake-up state, and the co-processor is a low-power processor configured to process data in a standby state. In some embodiments, the processor 701 is integrated with a graphics processing unit (GPU), which is configured to render and draw the content to be displayed by the display. In some embodiments, the processor 701 further includes an artificial intelligence (AI) processor that is configured to handle computational operations related to machine learning.

The memory 702 includes one or more non-transitory computer-readable storage media. The memory 702 also includes a high-speed random access memory, and a non-transitory memory, such as one or more disk storage devices and flash memory storage devices. In some embodiments, the non-transitory computer-readable storage medium in the memory 702 is configured to store at least one instruction. The at least one instruction, when loaded and executed by the processor 701, causes the processor 701 to perform the audio synthesis method according to the method embodiments in this disclosure.

In some embodiments, the terminal device 700 further includes a peripheral device interface 703 and at least one peripheral device. The processor 701, the memory 702, and the peripheral device interface 703 are connected to each other via buses or signal lines. Each peripheral device is connected to the peripheral device interface 703 via a bus, a signal line, or a circuit board. Specifically, the peripheral device includes at least one of a radio frequency circuit 704, a display 705, a camera component 706, an audio circuit 707, a positioning component 708, and a power supply 709.

The peripheral device interface 703 is configured to connect at least one peripheral device, related to input/output (I/O), to the processor 701 and the memory 702. In some embodiments, the processor 701, the memory 702, and the peripheral device interface 703 are integrated on the same chip or circuit board. In some other embodiments, any one or two of the processor 701, the memory 702, and the peripheral device interface 703 may be implemented on a separate chip or circuit board, which is not limited herein.

The radio frequency circuit 704 is configured to receive and transmit radio frequency (RF) signals, also known as electromagnetic signals. The radio frequency circuit 704 is communicated with communication networks and other communication devices over electromagnetic signals. The radio frequency circuit 704 converts electrical signals to electromagnetic signals and transmits the electromagnetic signals, or converts the received electromagnetic signals to electrical signals. In some embodiments, the radio frequency circuit 704 includes an antenna system, an RF transceiver, one or more amplifiers, a tuner, an oscillator, a digital signal processor, a codec chipset, a subscriber identity module card, and the like. The radio frequency circuit 704 is communicated with other terminals by at least one wireless communication protocol. The wireless communication protocols include, but are not limited to: World Wide Web, Metropolitan Area Networks, Intranet, various generations of mobile communication networks (2G, 3G, 4G, and 5G), Wireless Local Area Networks, and/or Wireless Fidelity (WiFi) network. In some embodiments, the radio frequency circuit 704 further includes circuits related to near-field communication (NFC), which is not limited herein.

The display 705 is configured to display a user interface (UI). The UI includes graphics, text, icons, videos, and any combination thereof. When the display 705 is a touch display, the display 705 further has the ability to capture a touch signal at or above a surface of the display 705. This touch signal is input into the processor 701 for processing as a control signal. In this case, the display 705 is further configured to provide a virtual button and/or a virtual keyboard, also referred to as a soft button and/or a soft keyboard. In some embodiments, there is one display 705, provided on a front panel of the terminal device 700; in other embodiments, there are at least two displays 705 respectively provided on different surfaces of the terminal device 700, or the at least two displays 705 are in a folded design. In other embodiments, the display 705 is flexible, provided on a curved surface or a folded surface of the terminal device 700. Even more, the display 705 is designed to be in a non-rectangular irregular shape, i.e., a shaped screen. The display 705 is prepared using materials such as liquid crystal display (LCD), organic light-emitting diode (OLED), and the like.

The camera component 706 is configured to capture images or videos. In some embodiments, the camera component 706 includes a front camera and a rear camera. Typically, the front camera is provided on the front panel of the terminal device 700 and the rear camera is provided on the back of the terminal device 700. In some embodiments, there are at least two rear cameras, each of which is any one of a main camera, a depth-of-field camera, a wide-angle camera, and a telephoto camera. In this way, a background defocusing function is achieved by the fusion of the main camera and the depth-of-field camera, a panoramic shooting function and a virtual reality (VR) shooting function are achieved by the fusion of the main camera and the wide-angle camera, and other functions are achieved. In some embodiments, the camera component 706 also includes a flash, which is a single-color temperature flash or a dual-color temperature flash. The dual color temperature flash is a combination of a warm light flash and a cool light flash, which is configured to compensate for light at different color temperatures.

The audio circuit 707 includes a microphone and a speaker. The microphone is configured to capture sound waves from users and the environment and convert the sound waves into electrical signals to be input into the processor 701 for processing or into the radio frequency circuit 704 for voice communication. For the purpose of stereo sound acquisition or noise reduction, there are a plurality of microphones, which are respectively provided at different parts of the terminal device 700. The microphones are array microphones or omnidirectional capture type microphones. The speaker is configured to convert electrical signals from the processor 701 or radio frequency circuit 704 into sound waves. The speaker is a conventional thin film speaker or a piezoelectric ceramic speaker. When the speaker is the piezoelectric ceramic speaker, it is possible to convert the electrical signals not only to sound waves that are audible to humans, but also to sound waves that are inaudible to humans for purposes such as ranging. In some embodiments, the audio circuit 707 also includes a headphone jack.

The positioning component 708 is configured to locate a current geographic location of the terminal device 700 to implement navigation or location-based service (LBS). The positioning component 708 may be the United States' Global Positioning System (GPS), Russia's Global Navigation Satellite System (GLONASS), China's BeiDou Navigation Satellite System (BDS), and the European Union's Galileo.

The power supply 709 is configured to power various assemblies in the terminal device 700. The power supply 709 is alternating current, direct current, a disposable battery, or a rechargeable battery. When the power supply 709 includes the rechargeable battery, the rechargeable battery is a wired rechargeable battery or a wireless rechargeable battery. The wired rechargeable battery is a battery that is charged via a wired line and the wireless rechargeable battery is a battery that is charged via a wireless coil. The rechargeable battery also supports the fast charging technology.

In some embodiments, the terminal device 700 further includes one or more sensors 170. The one or more sensors 170 include, but are not limited to: an acceleration sensor 711, a gyroscope sensor 712, a pressure sensor 713, a fingerprint sensor 714, an optical sensor 715, and a proximity sensor 716.

The acceleration sensor 711 detects magnitudes of acceleration on three coordinate axes of a coordinate system established in terms of the terminal device 700. For example, the acceleration sensor 711 is configured to detect components of gravity acceleration on the three coordinate axes. The processor 701 controls the display 705 to display the user interface in a landscape view or a portrait view based on gravity acceleration signals collected by the acceleration sensor 711. The acceleration sensor 711 is also configured to collect game or user motion data.

The gyroscope sensor 712 detects a body direction and a rotation angle of the terminal device 700, and the gyroscope sensor 712 cooperates with the acceleration sensor 711 to collect 3D movements of the user on the terminal device 700. The processor 701, based on the data collected by the gyroscope sensor 712, implements the following functions: motion sensing (e.g., changing the UI based on a tilt operation of the user), image stabilization during shooting, game control, and inertial navigation.

The pressure sensor 713 is provided in a side bezel of the terminal device 700 and/or a lower layer of the display 705. When the pressure sensor 713 is provided in the side bezel of the terminal device 700, a grip signal from the user to the terminal device 700 is detected, and the processor 701 performs right-left handed recognition or shortcut operation based on the grip signal collected by the pressure sensor 713. When the pressure sensor 713 is provided in the lower layer of the display 705, the processor 701 achieves the control of operability controls on the UI interface according to the user's pressure operation on the display 705. The operability control includes at least one of a button control, a scroll bar control, an icon control, and a menu control.

The fingerprint sensor 714 is configured to collect a fingerprint of the user. The processor 701 recognizes an identity of the user based on the fingerprint collected by the fingerprint sensor 714, or, the fingerprint sensor 714 recognizes an identity of the user based on the collected fingerprint. In the case that the identity of the user is recognized as a trusted identity, the user is authorized by the processor 701 to perform relevant sensitive operations, which include unlocking the screen, viewing encrypted information, downloading software, making payments, and changing settings. The fingerprint sensor 714 is provided on the front, back, or side of the terminal device 700. When the terminal device 700 includes a physical button or a vendor logo, the fingerprint sensor 714 is integrated with the physical button or the vendor logo.

The optical sensor 715 is configured to collect ambient light intensity. In some embodiments, the processor 701 controls the display brightness of the display 705 based on the ambient light intensity collected by the optical sensor 715. Specifically, when the ambient light intensity is high, the display brightness of the display 705 is turned up; and when the ambient light intensity is low, the display brightness of the display 705 is turned down. In other embodiments, the processor 701 also dynamically adjusts shooting parameters of the camera component 706 based on the ambient light intensity collected by the optical sensor 715.

The proximity sensor 716, also known as a distance sensor, is typically provided on the front panel of the terminal device 700. The proximity sensor 716 is configured to collect a distance between the user and the front of the terminal device 700. In some embodiments, when the proximity sensor 716 detects that the distance between the user and the front of the terminal device 700 gradually becomes small, the display 705 is controlled by the processor 701 to switch from an on-state to a locked state. When the proximity sensor 716 detects that the distance between the user and the front of the terminal device 700 gradually becomes large, the display 705 is controlled by the processor 701 to switch from the locked screen state to the on-state.

It will be appreciated by those skilled in the art that the structure illustrated in FIG. 7 does not constitute any limitation to the terminal device 700, and may include more or fewer assemblies than illustrated, or a combination of certain assemblies, or a different arrangement of assemblies.

FIG. 8 is a schematic structural diagram of a server according to some embodiments of the present disclosure. The server 800, which varies considerably depending on configuration or performance, includes one or more processors (Central Processing Units, CPUs) 801 and one or more memories 802. At least one program code, stored in the one or more memories 802, when loaded and executed by the one or more processors 801 of the server, causes the server to perform the audio synthesis method according to the various method embodiments described above. The server 800 also has assemblies such as a wired or wireless network interface, a keyboard, and an input/output interface for input/output. The server 800 includes other assemblies for implementing device functions, which are not repeated herein.

In some embodiments, a non-transitory computer-readable storage medium storing at least one program code is provided. The at least one program code, when loaded and executed by a processor of a computer, causes the computer to perform any of the audio synthesis methods described above.

In some embodiments, the computer-readable storage media described above are a read-only memory (ROM), a random access memory (RAM), a compact disc read-only memory (CD-ROM), a magnetic tape, a floppy disk, an optical data storage device, and the like.

In some embodiments, a computer program or computer program product storing at least one computer instruction is provided. The at least one computer instruction, when loaded and executed by a processor of a computer, causes the computer to perform any of the audio synthesis methods described above.

It should be understood that the term “a plurality of” mentioned in the embodiments of the present disclosure indicates two or more. The term “and/or” mentioned in the embodiments of the present disclosure indicates three relationships between contextual objects. For example, A and/or B may mean that A exists alone, A and B exist at the same time, and B exists alone. The symbol “/” generally denotes an “OR” relationship between contextual objects.

Described above are merely embodiments of the present disclosure, and are not intended to limit the present disclosure. Therefore, any modifications, equivalent substitutions, improvements, and the like made within the intentions and principles of the present disclosure shall be included in the protection scope of the present disclosure.

1. An audio synthesis method, comprising:
acquiring music score data of target music, wherein the music score data of the target music comprises audio data identifiers and performance time information corresponding to a plurality of sub-audios, an instrumental timbre corresponding to each of the sub-audios being matched with a hearing-impaired hearing timbre;
acquiring the sub-audios based on the audio data identifiers corresponding to each of the sub-audios; and
generating a synthetic audio of the target music by performing a fusion process on the sub-audios based on the performance time information corresponding to each of the sub-audios.

2. The method according to claim 1, wherein in a frequency spectrum of an instrument corresponding to each of the sub-audios, a ratio of energy of a low-frequency band to energy of a high-frequency band is greater than a ratio threshold, wherein the low-frequency band is a band lower than a frequency threshold, the high-frequency band is a band higher than the frequency threshold, and the ratio threshold indicates a condition that the ratio of the energy of the low-frequency band to the energy of the high-frequency band in a frequency spectrum of an audio which is capable of being heard by hearing-impaired people needs to be satisfied.

3. The method according to claim 1, wherein acquiring the music score data of the target music comprises:
determining the audio data identifiers and the performance time information corresponding to the plurality of sub-audios based on a tempo, a time signature, and a chord list of the target music.

4. The method according to claim 3, wherein
the plurality of sub-audios comprise a drumbeat sub-audio and a chord sub-audio; and
determining the audio data identifiers and the performance time information corresponding to the plurality of sub-audios based on the tempo, the time signature, and the chord list of the target music comprises:
determining an audio data identifier and performance time information corresponding to the drumbeat sub-audio based on the tempo and the time signature of the target music;
determining an audio data identifier and performance time information corresponding to the chord sub-audio based on the tempo, the time signature, and the chord list of the target music; and
acquiring the audio data identifiers and the performance time information corresponding to the plurality of sub-audios by composing the audio data identifier and the performance time information corresponding to the drumbeat sub-audio and the audio data identifier and the performance time information corresponding to the chord sub-audio.

5. The method according to claim 4, wherein determining the audio data identifier and the performance time information corresponding to the drumbeat sub-audio based on the tempo and the time signature of the target music comprises:
determining an audio data identifier corresponding to the time signature and the tempo of the target music, and determining the audio data identifier corresponding to the time signature and the tempo of the target music as the audio data identifier corresponding to the drumbeat sub-audio; and
determining the performance time information corresponding to the drumbeat sub-audio based on the time signature and the tempo of the target music.

6. The method according to claim 4, wherein
the chord list comprises a chord identifier and performance time information corresponding to the chord identifier; and
determining the audio data identifier and the performance time information corresponding to the chord sub-audio based on the tempo, the time signature, and the chord list of the target music comprises:
determining an audio data identifier corresponding to the chord identifier based on the tempo and the time signature of the target music; and
determining the performance time information and the audio data identifier corresponding to the chord identifier as the performance time information and the audio data identifier corresponding to the chord sub-audio.

7. The method according to claim 1, wherein generating the synthetic audio of the target music by performing the fusion process on the sub-audios based on the performance time information corresponding to each of the sub-audios comprises:
acquiring an intermediate audio of the target music by performing the fusion process on the sub-audios based on the performance time information corresponding to each of the sub-audios; and
acquiring the synthetic audio of the target music by performing a frequency domain compression process on the intermediate audio of the target music.

8. The method according to claim 7, wherein acquiring the synthetic audio of the target music by performing the frequency domain compression process on the intermediate audio of the target music comprises:
acquiring a first sub-audio of a first frequency interval corresponding to the intermediate audio and a second sub-audio of a second frequency interval corresponding to the intermediate audio, wherein a frequency of the first frequency interval is less than a frequency of the second frequency interval;
acquiring a third sub-audio by performing a gain compensation on the first sub-audio based on a first gain coefficient, and acquiring a fourth sub-audio by performing a gain compensation on the second sub-audio based on a second gain coefficient;
acquiring a fifth sub-audio by performing a compression frequency shift process on the fourth sub-audio, wherein a lower limit of a third frequency interval corresponding to the fifth sub-audio is equal to a lower limit of the second frequency interval; and
acquiring the synthetic audio of the target music by performing the fusion process on the third sub-audio and the fifth sub-audio.

9. The method according to claim 8, wherein acquiring the fifth sub-audio by performing the compression frequency shift process on the fourth sub-audio comprises:
acquiring a sixth sub-audio by performing a frequency compression of a target ratio on the fourth sub-audio; and
acquiring the fifth sub-audio by performing a frequency upshift of a target value on the sixth sub-audio, wherein the target value is equal to a difference between the lower limit of the second frequency interval and a lower limit of a fourth frequency interval corresponding to the sixth sub-audio.

10. A computer device, comprising: a processor and a memory storing at least one program code, wherein the processor, when loading and executing the at least one program code, is caused to perform:
acquiring music score data of target music, wherein the music score data of the target music comprises audio data identifiers and performance time information corresponding to a plurality of sub-audios, an instrumental timbre corresponding to each of the sub-audios being matched with a hearing-impaired hearing timbre;
acquiring the sub-audios based on the audio data identifiers corresponding to each of the sub-audios; and
generating a synthetic audio of the target music by performing a fusion process on the sub-audios based on the performance time information corresponding to each of the sub-audios.

11. A non-transitory computer-readable storage medium storing at least one program code, wherein the at least one program code, when loaded and executed by a processor of a computer, causes the computer to perform an audio synthesis method:
acquiring music score data of target music, wherein the music score data of the target music comprises audio data identifiers and performance time information corresponding to a plurality of sub-audios, an instrumental timbre corresponding to each of the sub-audios being matched with a hearing-impaired hearing timbre;
acquiring the sub-audios based on the audio data identifiers corresponding to each of the sub-audios; and
generating a synthetic audio of the target music by performing a fusion process on the sub-audios based on the performance time information corresponding to each of the sub-audios.

12. A computer program product storing at least one computer instruction, wherein the at least one computer instruction, when loaded and executed by a processor of a computer, causes the computer to perform the audio synthesis method as defined in claim 1.

13. The computer device according to claim 10, wherein in a frequency spectrum of an instrument corresponding to each of the sub-audios, a ratio of energy of a low-frequency band to energy of a high-frequency band is greater than a ratio threshold, wherein the low-frequency band is a band lower than a frequency threshold, the high-frequency band is a band higher than the frequency threshold, and the ratio threshold indicates a condition that the ratio of the energy of the low-frequency band to the energy of the high-frequency band in a frequency spectrum of an audio which is capable of being heard by hearing-impaired people needs to be satisfied.

14. The computer device according to claim 10, wherein the processor, when loading and executing the at least one program code, is caused to perform:
determining the audio data identifiers and the performance time information corresponding to the plurality of sub-audios based on a tempo, a time signature, and a chord list of the target music.

15. The computer device according to claim 14, wherein
the plurality of sub-audios comprise a drumbeat sub-audio and a chord sub-audio; and
wherein the processor, when loading and executing the at least one program code, is caused to perform:
determining an audio data identifier and performance time information corresponding to the drumbeat sub-audio based on the tempo and the time signature of the target music;
determining an audio data identifier and performance time information corresponding to the chord sub-audio based on the tempo, the time signature, and the chord list of the target music; and
acquiring the audio data identifiers and the performance time information corresponding to the plurality of sub-audios by composing the audio data identifier and the performance time information corresponding to the drumbeat sub-audio and the audio data identifier and the performance time information corresponding to the chord sub-audio.

16. The computer device according to claim 15, wherein the processor, when loading and executing the at least one program code, is caused to perform:
determining an audio data identifier corresponding to the time signature and the tempo of the target music, and determining the audio data identifier corresponding to the time signature and the tempo of the target music as the audio data identifier corresponding to the drumbeat sub-audio; and
determining the performance time information corresponding to the drumbeat sub-audio based on the time signature and the tempo of the target music.

17. The computer device according to claim 15, wherein
the chord list comprises a chord identifier and performance time information corresponding to the chord identifier; and
wherein the processor, when loading and executing the at least one program code, is caused to perform:
determining an audio data identifier corresponding to the chord identifier based on the tempo and the time signature of the target music; and
determining the performance time information and the audio data identifier corresponding to the chord identifier as the performance time information and the audio data identifier corresponding to the chord sub-audio.

18. The computer device according to claim 10, wherein the processor, when loading and executing the at least one program code, is caused to perform:
acquiring an intermediate audio of the target music by performing the fusion process on the sub-audios based on the performance time information corresponding to each of the sub-audios; and
acquiring the synthetic audio of the target music by performing a frequency domain compression process on the intermediate audio of the target music.

19. The computer device according to claim 18, wherein the processor, when loading and executing the at least one program code, is caused to perform:
acquiring a first sub-audio of a first frequency interval corresponding to the intermediate audio and a second sub-audio of a second frequency interval corresponding to the intermediate audio, wherein a frequency of the first frequency interval is less than a frequency of the second frequency interval;
acquiring a third sub-audio by performing a gain compensation on the first sub-audio based on a first gain coefficient, and acquiring a fourth sub-audio by performing a gain compensation on the second sub-audio based on a second gain coefficient;
acquiring a fifth sub-audio by performing a compression frequency shift process on the fourth sub-audio, wherein a lower limit of a third frequency interval corresponding to the fifth sub-audio is equal to a lower limit of the second frequency interval; and
acquiring the synthetic audio of the target music by performing the fusion process on the third sub-audio and the fifth sub-audio.

20. The computer device according to claim 19, wherein the processor, when loading and executing the at least one program code, is caused to perform:
acquiring a sixth sub-audio by performing a frequency compression of a target ratio on the fourth sub-audio; and
acquiring the fifth sub-audio by performing a frequency upshift of a target value on the sixth sub-audio, wherein the target value is equal to a difference between the lower limit of the second frequency interval and a lower limit of a fourth frequency interval corresponding to the sixth sub-audio.
